(19) United States
(12) Patent Application Publication
(10) Pub. No.: US 2026/0261237 A1
(43) Pub. Date: Sep. 3, 2026

(54) Solar Cable Cradle Fixings

(71) Applicant: HellermannTyton Corporation, Milwaukee, WI (US)

(72) Inventors: Scott G. Klos, Grafton, WI (US); Michael Toll, Whitefish Bay, WI (US); Alexander Mann, Port Washington, WI (US)

(73) Assignee: HellermannTyton Corporation, Milwaukee, WI (US)

(21) Appl. No.: 19/269,995

(22) Filed: Jul. 15, 2025

Related U.S. Application Data
(60) Provisional application No. 63/765,356, filed on Feb. 28, 2025.

(51) Int. Cl. H02S 40/30; H02G 3/32

(52) U.S. Cl. CPC H02S 40/30; H02G 3/32

(57) ABSTRACT

This document describes solar cable cradle fixings (e.g., “cradle fixings”) for routing and securing photovoltaic cables in photovoltaic system installations. An example cradle fixing apparatus includes a mount portion, a cradle portion, and a gate portion. The mount portion is configured to mount on a support structure. The cradle portion extends from the mount portion. The cradle portion defines a channel and a cradle opening. The cradle portion is configured to receive an object (e.g., electrical cable) through the cradle opening and into the channel. The gate portion also extends from the mount portion and is configured to retain the object in the channel between the cradle portion and the gate portion.

### INCORPORATION BY REFERENCE

This application claims the benefit of U.S. Provisional Application No. 63/765,356, filed Feb. 28, 2025, the disclosure of which is incorporated herein by reference.

### BACKGROUND

Photovoltaic systems are widely utilized for generating electrical power. Such systems commonly include one or more panels of photovoltaic cells, often referred to as solar panels, which are mounted on a support structure. The support structure may include one or more frames, rails, columns, purlins, mounting brackets, and the like. In various applications, the solar panels may be fixed in place on the support structure, while in others, the support structure may incorporate a solar tracker to orient the panels towards the Sun. An example solar tracker support structure typically includes one or more column supports and a torque tube that is rotationally mounted on the column support, with solar panels affixed to the torque tube. The rotation of the torque tube facilitates the orientation of the solar panels.

In such a typical photovoltaic system installation, the electrical output from the solar panels is transferred to an electrical grid or an electrical storage device, such as a battery, via one or more electrical cables. These electrical cables, which may include photovoltaic cables, solar panel cables, and/or harness string cabling, are routed, secured, supported, and/or connected to the support structure of the photovoltaic system at a mount location using a routing component that includes a cable support opening. The cable support opening is configured to receive and securely hold the electrical cables during use. If the electrical cables are not securely held, they may fall out of the cable support opening as the torque tube and routing component attached thereto rotate.

Due to the number of different support structure and equipment manufacturers, a number of different mount locations and configurations are possible, including frame components that can be wrapped around, frame components that a hanger can be hung from, frame components that include unused mounting holes, existing bolt studs, and the like.

Many different routing components can be used to attach an electrical cable to a photovoltaic system installation frame component (e.g., support column, torque tube). In a first example, the routing component includes a stud mount fixing that is pushed and/or rotated onto exposed threads of an existing mounting bolt and an object support for supporting the electrical cable. In a second example, the routing component includes a cable tie that is looped around a frame component and the electrical cable. In a third example, the routing component is a P-clamp fixing with a flange defining an aperture that is fastened to a frame component. In a fourth example, the routing component is a cable tie saddle that is configured to bolt onto a frame component. In a fifth example, the routing component is a cable tie with a button mount (e.g., fir tree mount) that is configured for insertion into an unused mounting hole in a frame component. In a sixth example, the routing component is a wire hanger fixing formed from a bent metal wire to feature an upper hook structure for connection to the frame component and a lower hook cradle structure for receiving electrical cables.

These issues frequently result in a system that is oftentimes cobbled together by technicians using whatever routing components are on hand and/or can be attached to the frame components. As a result, there is a continuing need for improved routing components for photovoltaic systems that overcome the aforementioned drawbacks of prior solutions.

### SUMMARY

This document describes cradle fixings (e.g., “solar cable cradle fixings”) for routing and securing photovoltaic cables in photovoltaic system installations. This document also describes techniques for manufacturing cradle fixings and techniques for using cradle fixings.

One general aspect includes an apparatus that includes a mount portion, a cradle portion, and a gate portion. The mount portion is configured to mount on a support structure. The cradle portion extends from the mount portion. The cradle portion defines a channel and a cradle opening. The cradle portion is configured to receive an object (e.g., electrical cable) through the cradle opening and into the channel. The gate portion also extends from the mount portion and is configured to retain the object in the channel between the cradle portion and the gate portion.

This Summary is provided to introduce simplified concepts of cradle fixings, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more implementations of cradle fixings are described with reference to the following Drawings.

FIG. 1 is a schematic representation of a solar cable cradle fixing.

FIG. 2 is a perspective view of a second solar cable cradle fixing (cradle fixing).

FIG. 3 is a side view of the cradle fixing of FIG. 2.

FIG. 3A is a sectional view along lines 3A-3A in FIG. 3.

FIG. 3B is a sectional view along lines 3B-3B in FIG. 3.

FIG. 4 is a front view of the cradle fixing of FIG. 2.

FIG. 4A is a sectional view along lines 4A-4A in FIG. 4.

FIG. 4B is an enlarged detail view of portion 4B in FIG. 4A, highlighting the internal components and their arrangement.

FIG. 5 is a top view of the cradle fixing of FIG. 2.

FIG. 6 is a bottom view of the cradle fixing of FIG. 2.

FIG. 6A is a sectional view along lines 6A-6A in FIG. 6.

FIG. 6B is an enlarged detail view of portion 6B in FIG. 6A, highlighting the internal components and their arrangement.

FIG. 7 is a back view of the cradle fixing of FIG. 2.

FIG. 8 is a first perspective environmental view of the cradle fixing of FIG. 2, illustrating a stud support structure.

FIG. 8A is a side view of the cradle fixing of FIG. 8, illustrating a first mounting position.

FIG. 8B is side view of the cradle fixing of FIG. 8, illustrating a second mounting position.

FIG. 9 is a second perspective environmental view of the cradle fixing of FIG. 2, illustrating a cable tie and a torque tube support structure.

FIG. 10 is a third perspective environmental view of the cradle fixing of FIG. 2, illustrating a fastener and a cable tie.

FIG. 10A is the view of FIG. 10 with rigid tubing, the fastener, the panel support structure, and the cable tie.

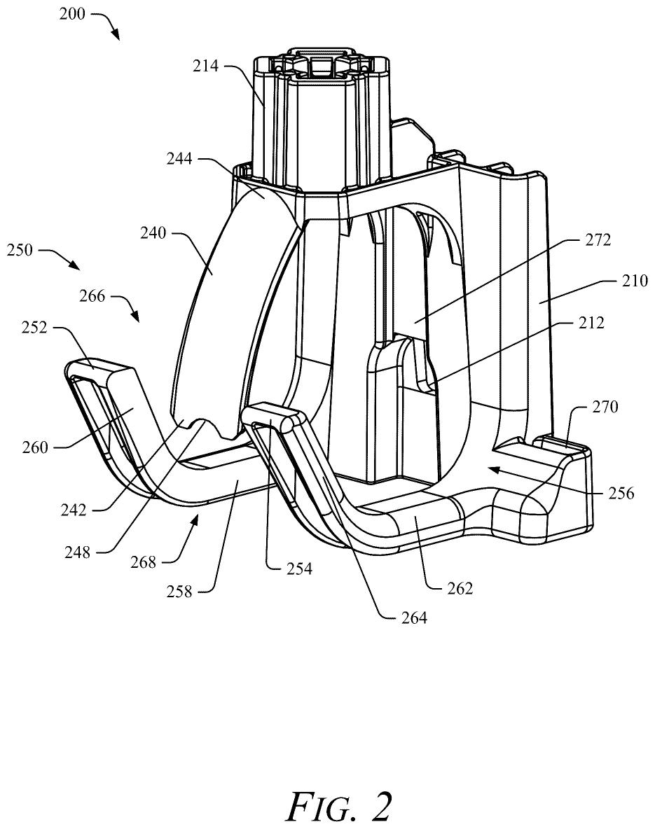

The following Detailed Description of example implementations of cradle fixing refers to the accompanying Drawings. In the Detailed Description, the first digit(s) of a reference character (e.g., call-out number) may correlate with the first figure number in which the reference character is labeled. For example, reference characters that start with a 2 (e.g., cradle fixing 200, gate portion 240) may represent details first called out with respect to FIG. 2. Further, the same reference characters in different Drawings may identify the same or similar features, elements, and/or parts.

### DETAILED DESCRIPTION

This document describes cradle fixings (e.g., “solar cable cradle fixings”) for routing and securing photovoltaic cables in photovoltaic system installations (e.g., for routing and securing photovoltaic cables along square torque tubes, along panel mounting brackets, and the like). This document also describes techniques for manufacturing cradle fixings and techniques for using cradle fixings. Aspects described herein address technical problems associated with the routing, securement, and/or connection of objects (e.g., electrical cables) to support structures, for example the support structure of a photovoltaic system (e.g., at one or more of column supports, torque tubes, mounting brackets, and the like). The disclosed cradle fixings result in a simpler installation and routing of objects (e.g., electrical cables) on and to a supporting structure. The disclosed cradle fixings also facilitate secure holding and retaining of the objects within the cradle during installation procedures and during use.

In one example, a cradle fixing includes a mount portion, a cradle portion, and a gate portion. The mount portion is configured to mount on a support structure. The cradle portion extends from the mount portion. The cradle portion defines a channel and a cradle opening. The channel may be an open-top channel. The cradle portion is configured to receive an object (e.g., electrical cable) through the cradle opening and into the channel. The gate portion also extends from the mount portion and is configured to retain the object in the channel between the cradle portion and the gate portion.

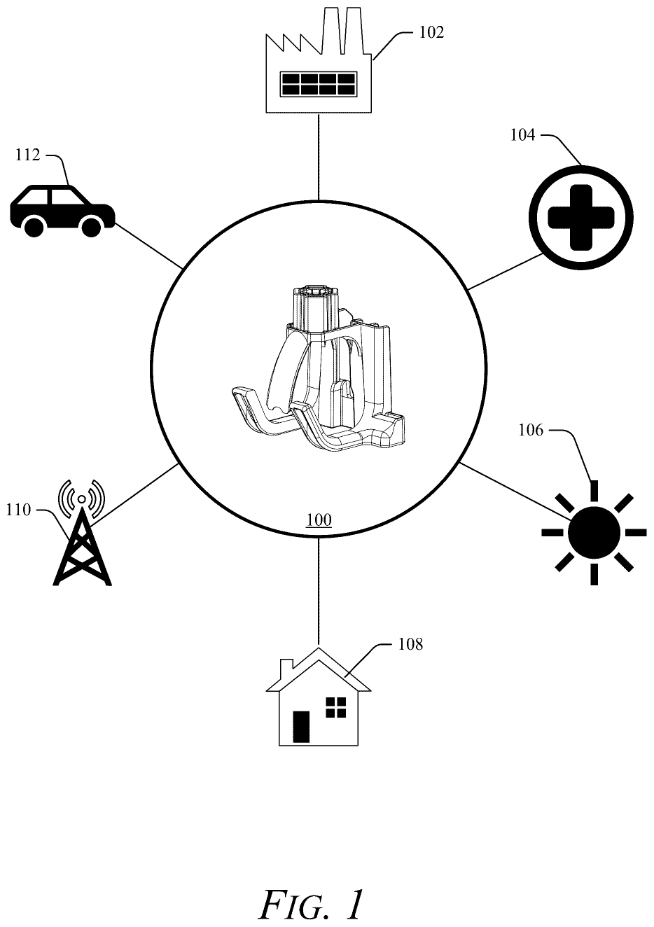

FIG. 1 is a schematic representation of a cradle fixing 100 for routing and securing photovoltaic cables in photovoltaic system installations. As discussed herein, the cradle fixing 100 may have particular application in the energy and utility markets 106 (e.g., for routing and securing photovoltaic cables in photovoltaic system installations). While this Detailed Description, including the Drawings, references these markets, a cradle fixing 100 may have application to bundles of objects in other markets, including but not limited to industrial and manufacturing markets 102, healthcare markets 104, consumer and commercial markets 108, and/or telecommunications and data infrastructure markets 110.

The industrial and manufacturing markets 102 include industrial automation and equipment, control panels, machine building, machinery, electrical enclosures, material handling systems (e.g., conveyors), cooling systems, heavy equipment (e.g., construction and mining machinery), agricultural technology (e.g., farming equipment), chemical (e.g., chemical processing equipment), robotics (e.g., automated robotic systems), original equipment manufacturers (OEMS), mechanical components, and mechanical systems. The healthcare markets 104 include medical equipment and technology, and dental equipment and technology. The energy and utility markets 106 include renewable energy systems (e.g., solar panels, solar arrays, wind turbines, hydroelectric generators), power generation and distribution, industrial lighting, and commercial lighting. The energy and utility markets 106 also include photovoltaic systems that include one or more panels (e.g., solar panels) of photovoltaic cells mounted on a support structure where the electrical output of the solar panels is transferred to the electrical grid or an electrical storage device (e.g., battery) through one or more electrical cables (photovoltaic cables). The consumer and commercial markets 108 include appliances (e.g., home and commercial appliances), heating, ventilation, and air conditioning (HVAC), and consumer electronic devices. The telecommunications and data infrastructure markets 110 include telecommunications (e.g., general telecom services), communications (e.g., communication systems and equipment), internet service providers (ISPs), cable television companies (CATV), infrastructure for data storage and processing (e.g., data centers), broadband (e.g., broadband internet services), and datacom (e.g., data communications equipment). The transportation markets 112 include manufacturing and components for vehicles, trucks, automobiles, rail conveyances (e.g., trains), marine craft (e.g., ships, boats), aircraft, and aerospace.

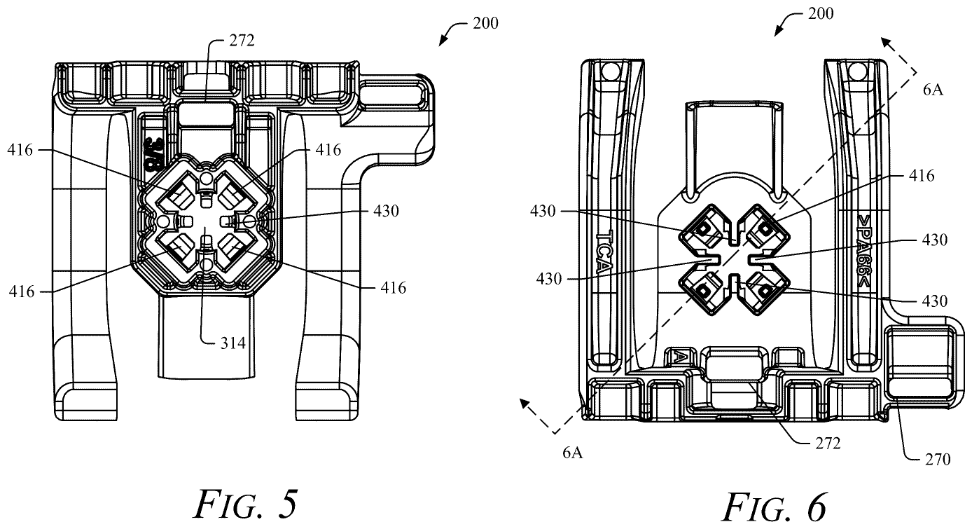

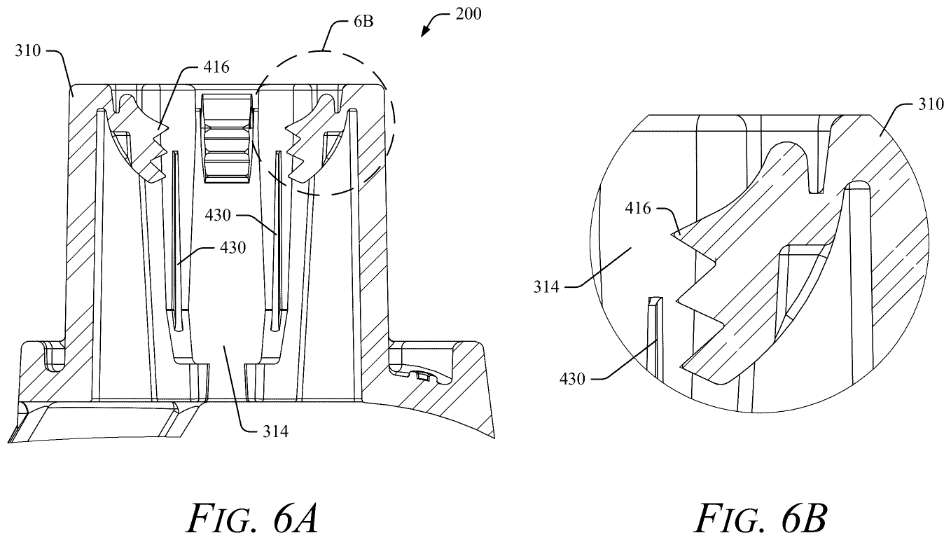

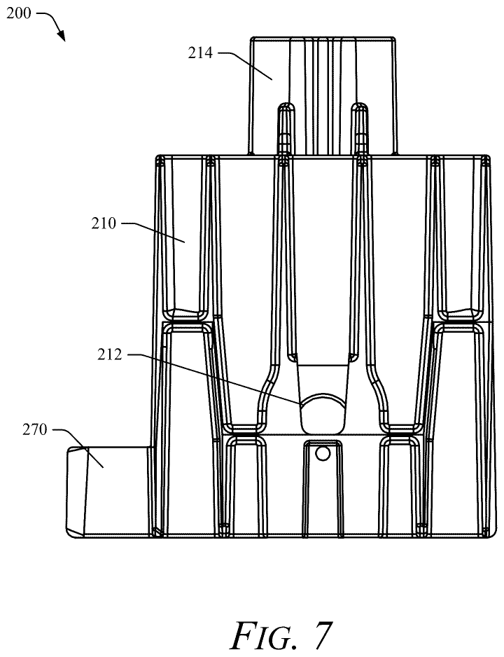

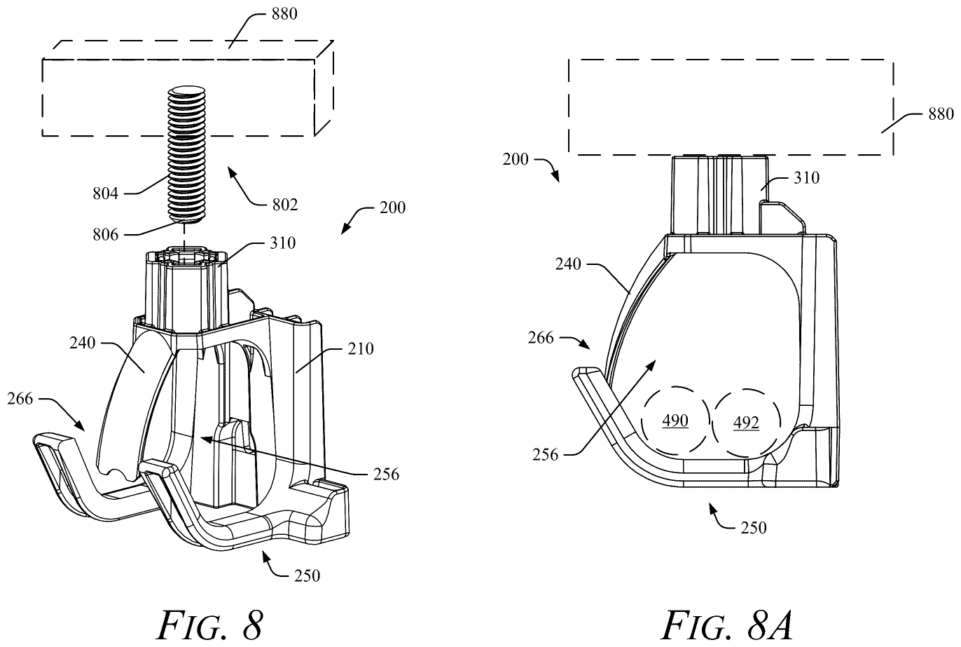

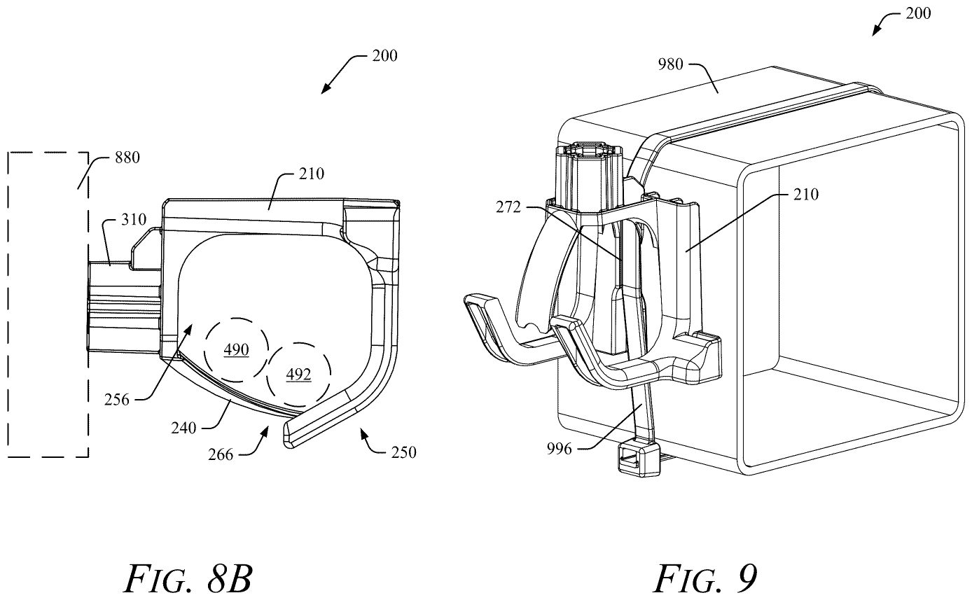

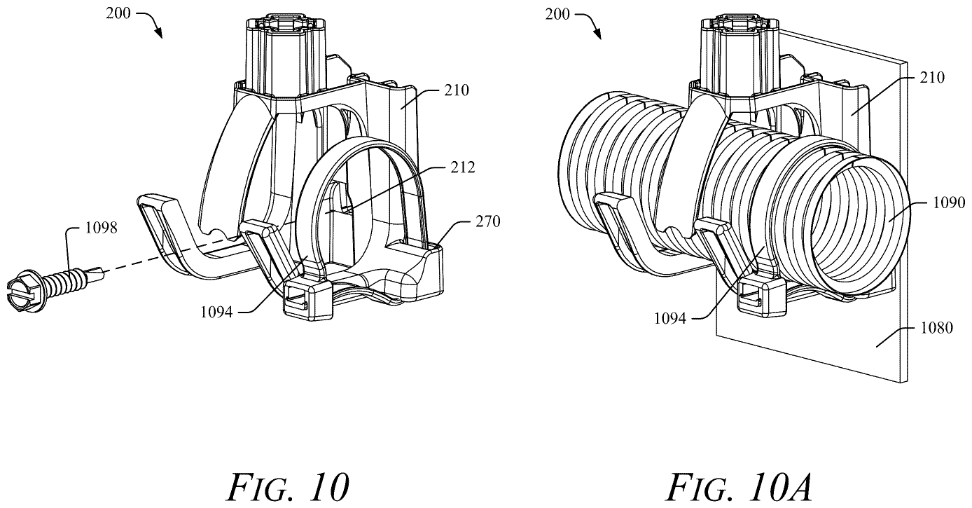

FIGS. 2-7 illustrate an example cradle fixing 200. The cradle fixing 200 is similar to the cradle fixing 100 illustrated in FIG. 1 and described above, except as detailed below. The cradle fixing 200 includes a mount portion 210 that is configured to mount on, mount to, or otherwise engage a support structure. For example, the support structure 880 illustrated in FIGS. 8-8B, the support structure 980 illustrated in FIG. 9, and/or the support structure 1080 illustrated in FIG. 10A. As used herein, the term “support structure” is used to refer to machines, cabinets, housings, frames, frame rails, enclosures, vehicle chassis, panels, rails, support beams, cable routing channels, conveyor channel assemblies, workpieces, and the like. In one example, a support structure of a photovoltaic system may include one or more column supports, torque tubes, mounting brackets, and the like. A support structure may include a mount surface and/or a mount aperture defined therein (e.g., a slot, a channel, a bore, a threaded hole), and the like.

The mount portion 210 may include a stud mount connector 214 that is configured to receive an elongated fastener to attach the cradle fixing 200 to a support structure, a saddle connector 272 configured to receive a strap (e.g., cable tie) to attach the cradle fixing 200 to a support structure, and/or a mount hole connector 212 configured to receive a mechanical fastener to attach the cradle fixing 200 to a support structure. In aspects, one or more of the stud mount connector, saddle connector, or the mount hole connector may be omitted.

The stud mount connector 214 is configured to engage an elongated fastener (e.g., a stud, a threaded bolt) to attach the mount portion 210 to the support structure. To engage the elongated fastener to attach the mount portion 210 to the support structure, the stud mount connector 214 may be pushed onto the elongated fastener and/or twisted onto the elongated fastener. FIG. 8 illustrates an example use case for the cradle fixing 200 that utilizes a stud support structure that includes an elongated fastener 802 that extends from a support structure 880.

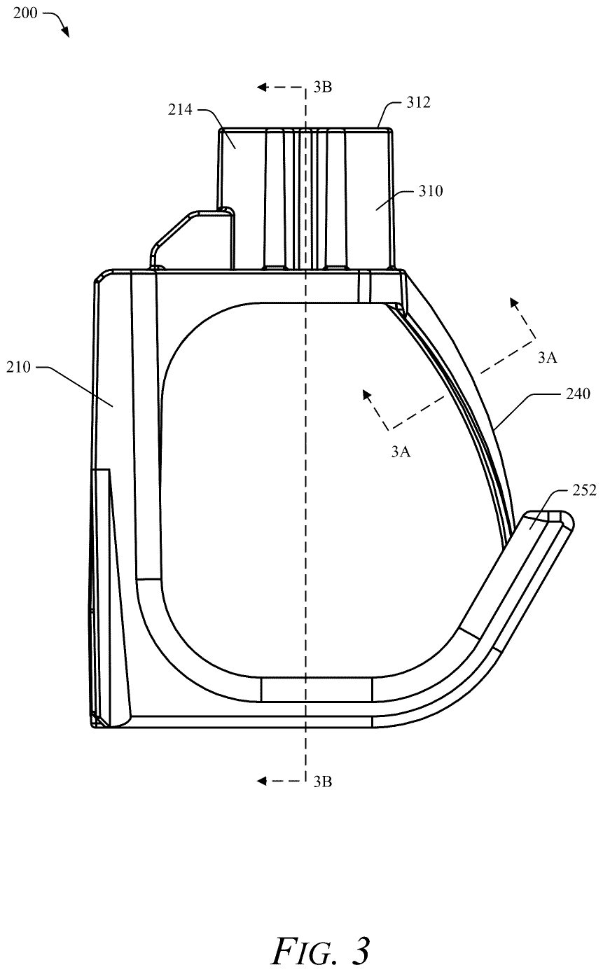

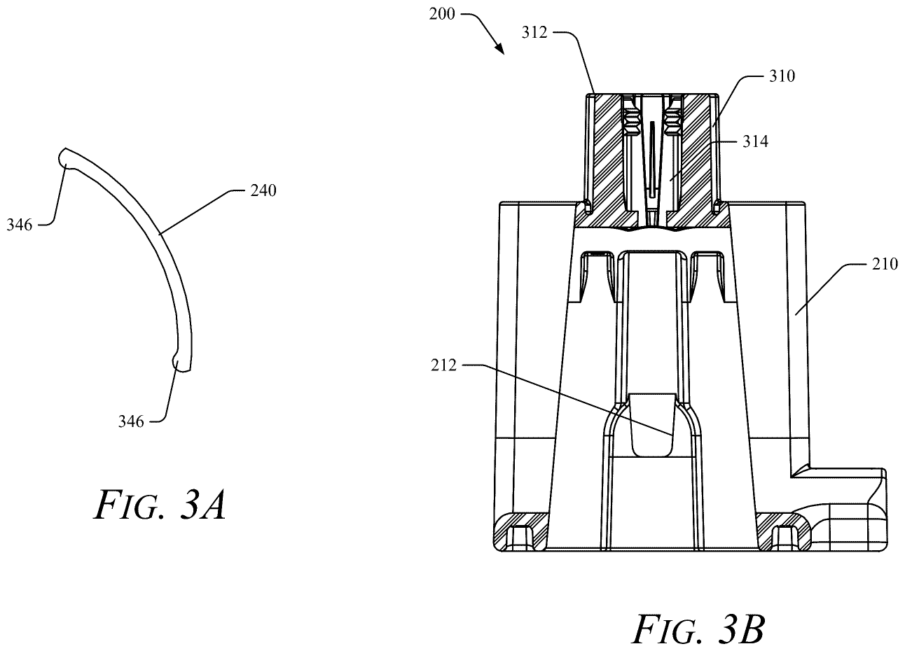

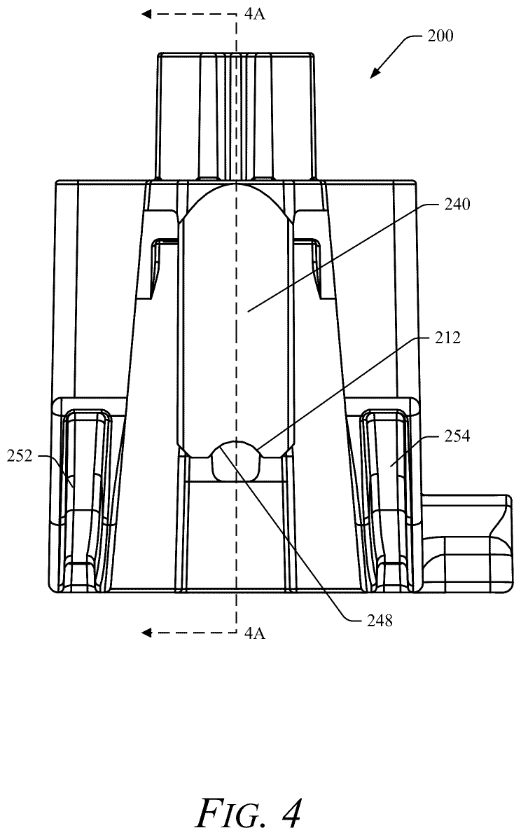

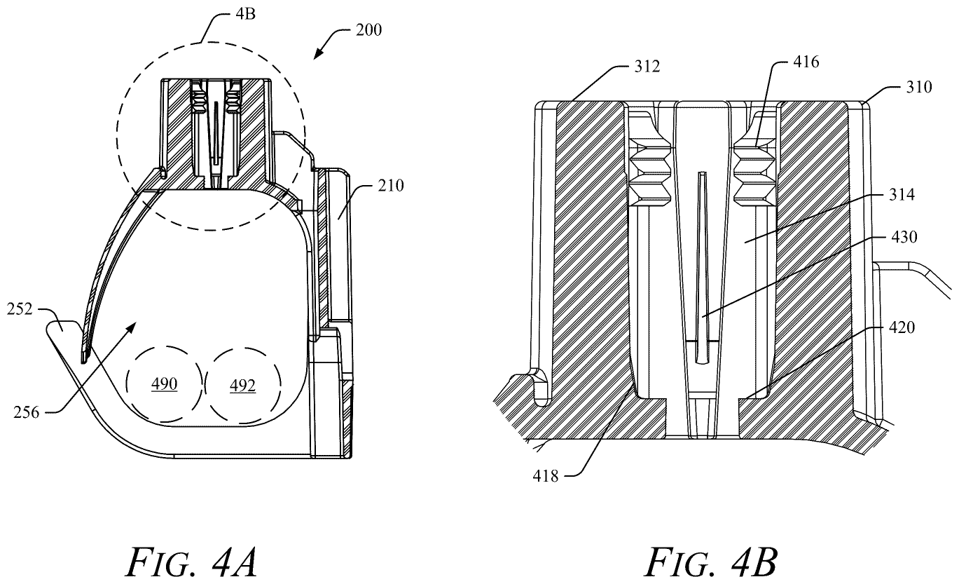

The stud mount connector 214 includes a locking head 310 with an upper surface 312 and a counterbore 314 (illustrated in FIG. 3B) that extends into at least a portion of the locking head 310 from the upper surface 312. The counterbore 314 is configured to receive at least a portion of the elongated fastener 802 therein. The counterbore 314 includes at least one thread-engaging pawl tooth 416 (illustrated in FIG. 4B) that is configured to engage the threads 804 of the elongated fastener 802. The engagement of the thread-engaging pawl tooth 416 to the threads 804 may be a releasable engagement. The counterbore 314 may include multiple (e.g., four) sets of thread-engaging pawls. The pawls may include thread-engaging teeth and may hingedly connect to the counterbore 314. In the configuration illustrated in FIGS. 4B, 5, 6A, and 6B, the counterbore 315 includes four sets of thread-engaging pawl teeth 416 that are spaced ninety degrees (90°) apart.

The counterbore 314 may include a chamfer 418 (e.g., chamfered portion) that is distal the upper surface 312, as illustrated in FIG. 4B. For example, the counterbore 314 may have a first diameter proximal the upper surface 312 and a second diameter distal the upper surface 312, with the first diameter larger than the second diameter. The chamfer 418 is configured to engage an end 806 of the elongated fastener 802 to provide tactile feedback to a technician when the locking head 310 is about fully inserted onto or screwed onto the elongated fastener 802 in a first direction. The counterbore 314 may further include a stop 420 that is located distal the upper surface 312. The stop 420 is configured to limit the insertion of the elongated fastener 802 into the counterbore 314. For example, upon insertion of the elongated fastener 802 fully into the counterbore 314, the end 806 of the elongated fastener 802 may bottom out against the stop 420, thereby limiting a further insertion of the elongated fastener 802 in the first direction.

The counterbore 314 may include at least one crush rib 430 that extends inwardly from a surface (e.g., internal surface) of the counterbore 314. In aspects, for example as illustrated in FIGS. 4B, 5, 6A, and 6B, the counterbore 314 may include four crush ribs that are spaced ninety degrees (90°) apart. The crush rib(s) 430 are configured to engage the elongated fastener 802 (e.g., by engaging the threads 804 of the elongated fastener 802) and may deform upon contact with the threads 804 of the elongated fastener 802 to provide interference. In this way, the crush rib(s) 430 may reduce the occurrence of wobbling of the stud mount connector 214 on the elongated fastener 802. The threads 804 of the elongated fastener 802 may cut into the crush rib(s) 430 to cause the deformation. The crush rib(s) 430 may extend axially to the counterbore 314 and may be equally spaced apart.

The mount portion 210 may define a mount hole connector therethrough that is configured to receive a mechanical fastener (e.g., machine screw, screw, bolt) to attach the mount portion to the support structure. For example, FIGS. 10 and 10A illustrate the mount portion 210 including a mount hole connector 212 that receives a mechanical fastener 1098 therethrough to attach the mount portion 210 to the support structure 1080. The support structure 1080 may include an mounting aperture (e.g., mounting hole, bore) defined therein for receiving the fastener.

In other aspects, the mount portion 210 may include a saddle connector 272 that is configured to receive a strap to secure the mount portion 210 to the support structure. The saddle connector 272 may be centered between the first cradle arm 252 and the second cradle arm 254, described below. In the aspect illustrated in FIGS. 4, 5, 6, and 9, the saddle connector 272 is a slot defined in the mount portion 210 that is configured to receive a strap 996 (cable tie 996) therethrough. The slot may be recessed in the mount portion 210. FIG. 9 illustrates a cable tie and a torque tube support structure use case for the cradle fixing 200 where a cable tie 996 is positioned in the saddle connector 272 and looped around the support structure 980 (e.g., a torque tube) to secure the mount portion 210 to the support structure.

The cradle fixing 200 also includes a cradle portion 250 that extends from the mount portion 210 and defines a channel 256 that includes a cradle opening 266. In aspects, the channel 256 may be an open-top channel. The cradle portion 250 may extend in an upwards direction from the mount portion 210 and towards the gate portion 240, as illustrated in FIG. 2. At least one object (e.g., electrical cable) may be passed through the cradle opening 266 and into the channel 256. For example, object 490 and object 492 are illustrated within the channel 256 in FIG. 4A. In this way, the cradle portion 250 is configured to receive the object(s) through the cradle opening 266 and into the channel 256.

The cradle portion 250 may include a first cradle arm 252 that is spaced apart from a second cradle arm 254. The first and second cradle arms may be rigid. A gap 268 is defined between the first cradle arm 252 and the second cradle arm 254. In aspects, the first arm cradle 252 and the second cradle arm 254 may be substantially parallel to one another. Unless context dictates otherwise, use herein of the term “substantially parallel” refers to a value, amount, or characteristic that departs from exactly parallel by less than or equal to 15 degrees, 10 degrees, 5 degrees, 3 degrees, 1 degree, 0.1 degree, or otherwise. The first cradle arm 252 includes a first receiver portion 258 that may extend substantially perpendicular to the mount portion 210 and a first upright portion 260 that extends obliquely from the first receiver portion 258. The second cradle arm 254 includes a second receiver portion 262 that may extend substantially perpendicular to the mount portion 210 and a second upright portion 264 that extends obliquely from the second receiver portion 262. Unless context dictates otherwise, use herein of the term “substantially perpendicular” refers to a value, amount, or characteristic that departs from exactly perpendicular by less than or equal to 15 degrees, 10 degrees, 5 degrees, 3 degrees, 1 degree, 0.1 degree, or otherwise.

The cradle fixing 200 includes a gate portion 240 that extends from the mount portion 210. The gate portion 240 is configured to retain an object(s) (e.g., object 490, object 492) held within the channel 256, for example, between the cradle portion and the gate portion. In this way, the cradle portion 250 is configured to receive and securely hold the object(s) (e.g., electrical cables). If the object(s) are not securely held by the cradle portion, they may fall out of the cradle opening 266 if the support structure (e.g., torque tube) and the cradle fixing 200 attached thereto move (e.g., rotate), for example, as illustrated in FIGS. 8A and 8B. The gate portion 240 may extend in a downwards direction from the mount portion 210 and towards the cradle portion 250, as illustrated in FIG. 2.

The gate portion 240 may be arcuately-shaped and may curve downwardly from the mount portion 210 (e.g., from the stud mount connector 214) and towards the cradle portion 250 to retain the object(s) in the cradle portion 250 (e.g., in the channel 256). The arcuate shape of the gate portion 240 may be defined between a first radius disposed at a base 244 of the gate portion 240 and a second radius disposed at a tip 242 of the gate portion. In aspects, the second radius is larger than the first radius. The tip 242 may extend into the gap 268 to overlap the first cradle arm 252 and the second cradle arm 254, as illustrated in FIGS. 2, 3, and 4A. In this way, the gate portion 240 closes the channel 256.

A tip 242 of the gate portion 240 may define a notch 248 that is configured to receive a tool (e.g., a shaft of a bit driver, a shaft of a screwdriver) that is utilized to engage a mechanical fastener (e.g., screw 1098 of FIG. 10) configured for insertion through the mount hole connector, as illustrated in the aspect of FIG. 10. For example, FIG. 4 illustrates the mount hole connector 212 positioned behind the tip 242 of the gate portion 240 and accessible through the notch 248. In aspects, a notch may be omitted.

The cradle fixing 200 (e.g., the mount portion 210, the cradle portion 250) may include a strap connector 270 that is configured to receive a strap (e.g., cable tie 1094 illustrated in FIGS. 10 and 10A) to secure the object(s) 1090 routed in the channel 256. In this way, the objects are further secured in the channel 256. In FIG. 10A, object 1090 is a length of convolute tubing through which one or more objects (e.g., electrical cables) can be routed. The strap connector 270 may define a cable tie route that is substantially perpendicular to the channel 256. In aspects, a strap connector 270 may be omitted.

The gate portion 240 is flexible and configured to flex (e.g., bend, pivot) in a first direction relative to the cradle portion 250 to deflect the gate portion 240 away from the cradle opening 266 to permit access to the channel 256 through the cradle opening 266 (e.g., to insert an object into the channel). The gate portion 240 is configured to resist flexure in a second direction opposite the first direction. The gate portion 240 is resilient and configured to return to its original shape. To remove an object into the channel, additional force can be applied against the gate portion 240 to temporarily bend the gate portion 240 to open the cradle opening 266. After the force is removed, the gate portion 240 will move back into position to cover the cradle opening 266 of the channel 256.

As illustrated in FIG. 3A, the gate portion 240 may include a least one reinforcement portion 246 located on or adjacently to lateral edges of the gate portion 240. The reinforcement portions 246 stiffen and reinforce the gate portion 240. The thickness of the gate portion 240 may vary along its length from base 244 to the tip 242. For example, the gate portion 240 may be thicker at the base 244 and thinner at the tip 242. The curvature of the gate portion 240 may also vary along its length from base 244 to the tip 242. For example, the arcuate shape of the gate portion 240 may be defined between a first (smaller) radius disposed at a base 244 of the gate portion 240 and a second (larger) radius disposed at a tip 242 of the gate portion 240. Curvature of the gate portion 240 more at the base 244 may result in the base portion being stiffer than the tip portion. In these ways, a gate portion may be configured for flexibility, retention strength, overall feature size, and/or resilience to return original profile after flexing.

As illustrated in FIGS. 2 and 4A, a portion of the gate portion 240 may extend into the gap 268 to limit a movement of the object(s) (e.g., object 490) out of the channel 256. The portion of the gate portion 240 that extends into the gap 268 may limit the movement of the object out of the channel 256 as an angular position of the apparatus changes, for example, as illustrated in FIGS. 8A and 8B. The gate portion 240 is configured to flex between a closed position and an open position. The gate portion 240 extends into the gap 268 when the gate portion 240 is in the closed position. The cradle portion 250 may receive the object into the channel 256 through the cradle opening 266 when the gate portion 240 is in the open position. The closed position may be a default position for the cradle fixing 200.

As described above, FIG. 8 illustrates an example use case for the cradle fixing 200 that utilizes a stud support structure that includes an elongated fastener 802 that extends from a support structure 880. The locking head 310 of the cradle fixing 200 includes a counterbore 314 (not illustrated in FIG. 8), which includes at least one thread-engaging pawl tooth 416 (illustrated in FIG. 4B) that is configured to engage the threads 804 of the elongated fastener 802, which terminates in an end 806. FIG. 8A is a side view of the cradle fixing of FIG. 8, which illustrates a first mounting position. In the first mounting position, the cradle fixing 200 mounts to an underside of a support structure 880 and two objects (object 490, object 492) are inserted through the cable opening 266, deflecting the gate portion 240, and into the channel 256, with the objects resting on the cradle portion 250. FIG. 8B is side view of the cradle fixing of FIG. 8, which illustrates a second mounting position. In the second mounting position, the support structure 880 and the cradle fixing 200 have been rotated ninety (90) degrees and the objects now rest on the gate portion 240 and/or the cradle portion 250 in a gravity-load position, with the gate portion 240 preventing the objects from falling out of the channel 256. In this way, an angular position of the cradle fixing has changed from FIG. 8A to FIG. 8B.

As described above, FIG. 9 illustrates a cable tie and a torque tube support structure use case for the cradle fixing 200 where a cable tie 996 is positioned in the saddle connector 272 and looped around the support structure 980 (e.g., a torque tube) to secure the mount portion 210 to the support structure. Further, as described above, FIGS. 10 and 10A illustrates another use case for the cradle fixing 200, where a fastener 1098 is used to attach the cradle fixing 200 to the support structure 1080.

Also disclosed is an improved stud mount connector that is configured to attach a fixing (e.g., cradle fixing 200) to a support structure (e.g., support structure 380). The stud mount connector is similar to the stud mount connector 214 illustrated in FIGS. 2-7 with respect to the cradle fixing 200 and described above, except as detailed below. As such, the stud mount connector includes a locking head having an upper surface and a counterbore that extends into the locking head from the upper surface. The counterbore is configured to receive the elongated fastener. The counterbore includes at least one thread-engaging pawl that is configured to engage the threads of the elongated fastener. The counterbore may include multiple (e.g., four) sets of thread-engaging pawls and the pawls may include thread-engaging teeth. The pawls may hingedly connect to the counterbore. The counterbore may include a chamfer that is distal the upper surface. The chamfer is configured to engage an end of the elongated fastener to provide tactile feedback to a technician (e.g., when the locking head is fully inserted onto or screwed onto the elongated fastener in a first direction). The counterbore may further include a stop located distal the upper surface. The stop is configured to limit an insertion of the elongated fastener into the counterbore. For example, upon insertion of the elongated fastener fully into the counterbore, the end of the elongated fastener may bottom out against the stop, thereby limiting a further insertion of the elongated fastener further in the first direction. The counterbore may further include at least one crush rib that extends from a surface (e.g., internal surface) of the counterbore. In aspects, a counterbore may include four crush ribs. The crush rib(s) are configured to engage the elongated fastener (e.g., by engaging the threads of the elongated fastener) to reduce the occurrence of wobble of the stud mount connector on the elongated fastener. The crush rib(s) may extend axially to the counterbore and may be equally spaced apart.

The parts of the disclosed solar cable cradle fixings may be fabricated of any suitable material, including, but not limited to, a metal, a ceramic, a polymer (e.g., a polymeric material), and/or a composite. Suitable polymeric materials may include one or more of polyamide (PA), polypropylene (PP), polyethylene (PE), polyphenylene sulfide (PPS), polyether ether ketone (PEEK), polyaryletherketone (PAEK), ethylene tetrafluoroethylene (ETFE), polyacetal (POM), polybutylene terephthalate (PBT), ultraviolet stabilized polyacetal (POMUV), acrylonitrile styrene acrylate (ASA), cross-linked thermoplastics, partially cross-linked thermoplastics, higher-temperature resins, ultraviolet (UV) resistant resins, other thermoplastic materials, and the like, and copolymers, blends, or alloys thereof)) as well as fiber reinforced materials. A suitable polymeric material may include one or more additives (e.g., heat stabilizers (e.g., copper iodide), impact modifiers (e.g., polyolefin, urethane, rubber), UV stabilizers (e.g., carbon black, hindered amine light stabilizers (HALS)), flame retardants (e.g., nitrogen-based halogen-free flame retardants, melamine cyanurate, melamine borate, ammonium polyphosphate), colorants, and the like).

One or more of the parts (e.g., the mount portion 210, the gate portion 240, the cradle portion 250) of the disclosed solar cable cradle fixings may be formed of the same material as the other parts, or of a different material than the other parts. One or more of the parts (e.g., the mount portion 210, the gate portion 240, the cradle portion 250) of a solar cable cradle fixings may be integrally formed of a suitable material(s). The terms “integral” and “integrally formed” are used in this Detailed Description to describe elements that are formed in one piece (a single, unitary piece) and cannot be separably removed from each other without causing permanent structural damage to the piece. In implementations, one or more of the parts (e.g., the mount portion 210, the gate portion 240, the cradle portion 250) of the disclosed cradle fixings can be assembled from separate plastic parts and fixed together through welding, solvents, adhesives, and the like.

One or more of the parts (e.g., the mount portion 210, the gate portion 240, the cradle portion 250) of the disclosed solar cable cradle fixings may be formed through a suitable fabrication technique. A suitable fabrication technique may include one or more of an injection-molding process, an additive manufacturing process (e.g., a fused deposition modeling (FDM) process, a fused deposition modeling (FDM) process, a three-dimensional (3D) printing process), or another suitable process.

Some additional examples of techniques and apparatuses for solar cable cradle fixings are as follows:

Example 1. An apparatus comprising: a mount portion configured to mount on a support structure; a cradle portion that extends from the mount portion, the cradle portion defines a channel and a cradle opening, the cradle portion configured to receive an object through the cradle opening and into the channel; and a gate portion that extends from the mount portion, the gate portion configured to retain the object in the channel between the cradle portion and the gate portion.

Example 2. The apparatus of Example 1, wherein the gate portion is arcuately-shaped and curves downwardly towards the cradle portion to retain the object in the cradle portion.

Example 3. The apparatus of Example 1, wherein the gate portion is arcuately-shaped, a first radius is disposed at a base of the gate portion a second radius is disposed at a tip of the gate portion, and the second radius is larger than the first radius.

Example 4. The apparatus of Example 1, wherein the gate portion is configured to flex in a first direction relative to the cradle portion to deflect the gate portion away from the cradle opening to permit access to the channel through the cradle opening and the gate portion is configured to resist flexure in a second direction opposite the first direction.

Example 5. The apparatus of Example 1, wherein the cradle portion further comprises: a first cradle arm spaced apart from a second cradle arm to define a gap therebetween.

Example 6. The apparatus of Example 5, wherein a portion of the gate portion extends into the gap to limit a movement of the object out of the channel.

Example 7. The apparatus of Example 6, wherein the portion of the gate portion limits the movement of the object out of the channel as an angular position of the apparatus changes.

Example 8. The apparatus of Example 7, wherein the gate portion is configured to flex between a closed position and an open position, the gate portion configured to extend into the gap when the gate portion is in the closed position, and the cradle portion configured to receive the object into the channel through the cradle opening when the gate portion is in the open position.

Example 9. The apparatus of Example 1, wherein the mount portion comprises a stud mount connector configured to engage an elongated fastener that extends from the support structure to attach the mount portion to the support structure.

Example 10. The apparatus of Example 9, wherein the stud mount connector further comprises: a locking head that includes an upper surface and a counterbore that extends into the locking head from the upper surface, the counterbore configured to receive the elongated fastener the counterbore further comprising at least one thread-engaging pawl configured to engage threads of the elongated fastener.

Example 11. The apparatus of Example 10, wherein the counterbore further comprises: a chamfer distal the upper surface the chamfer configured to engage an end of the elongated fastener to provide tactile feedback to a technician.

Example 12. The apparatus of Example 10, wherein the counterbore further comprises: a stop distal the upper surface the stop configured to limit an insertion of the elongated fastener into the counterbore.

Example 13. The apparatus of Example 10, wherein the counterbore further comprises: at least one crush rib that extends from a surface of the counterbore, the crush rib configured to engage the elongated fastener to reduce wobble.

Example 14. The apparatus of Example 13, wherein the crush rib extends axially to the counterbore.

Example 15. The apparatus of Example 1, wherein the cradle portion further comprises: a first cradle arm comprising a first receiver portion that extends substantially perpendicular to the mount portion and a first upright portion that extends obliquely from the first receiver portion; and a second cradle arm comprising a second receiver portion that extends substantially perpendicular to the mount portion and a second upright portion that extends obliquely from the second receiver portion, the first cradle arm spaced apart from the second cradle arm.

Example 16. The apparatus of Example 1, the mount portion the cradle portion and the gate portion are integral.

Example 17. The apparatus of Example 1, further comprising: a strap connector configured to receive a strap to secure the object in the channel.

Example 18. The apparatus of Example 1, wherein the mount portion further comprises: a saddle configured to receive a strap to secure the mount portion to the support structure.

Example 19. The apparatus of Example 18, wherein the cradle portion further comprises: a first cradle arm spaced apart from a second cradle arm to define a gap therebetween, the saddle centered between the first cradle arm and the second cradle arm.

Example 20. The apparatus of Example 1, wherein the mount portion defines a mount hole connector therethrough that is configured to receive a mechanical fastener therethrough to attach the mount portion to the support structure, and a tip of the gate portion defines a notch configured to receive a tool that engages the mechanical fastener.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

The terms “rigid,” “flexible,” and “resilient,” may be used herein to distinguish characteristics of portions of certain features of the solar cable cradle fixings disclosed herein. Use of the term “rigid” indicates that the described element is devoid of flexibility such that it does not readily lose its overall shape when force is applied by hand, and in fact it may break if an attempt to bend it is made with sufficient force. Use of the term “flexible” indicates that the described element is capable of repeated bending such that it may be bent into different shapes and does not retain a general shape, but instead readily deforms when force is applied. Use of the term “resilient” indicates that the described element has such flexible features and also tends to return to its initial general shape without permanent deformation once a force that causes such flexure is removed.

In this description of aspects of solar cable cradle fixings, ordinal numbers such as “first” and “second” are used only to distinguish between different described objects and have no limitation on a location, a sequence, a priority, a quantity, content, or the like of the described objects. For example, a “first cradle arm” is used as an example, and there may be one or more “cradle arms.” Additionally, objects modified by different ordinal numbers may be the same or different objects. For example, if the described object is a “cradle arm,” a “first cradle arm” and a “second cradle arm” may be the same or different cradle arms.

In aspects, techniques and apparatuses for solar cable cradle fixings may include one or more of the features of the techniques and apparatuses illustrated in the Drawings and described herein. Although implementations for techniques and apparatuses for solar cable cradle fixings have been described in language specific to certain features and/or methods, the subject of the appended claims is not necessarily limited to the specific features or methods described. Rather, the specific features and methods are disclosed as example implementations of techniques and apparatuses for solar cable cradle fixings.

What is claimed is:

1. An apparatus comprising:
a mount portion configured to mount on a support structure;
a cradle portion that extends from the mount portion, the cradle portion defines a channel and a cradle opening, the cradle portion configured to receive an object through the cradle opening and into the channel; and
a gate portion that extends from the mount portion, the gate portion configured to retain the object in the channel between the cradle portion and the gate portion.

2. The apparatus of claim 1, wherein the gate portion is arcuately-shaped and curves downwardly towards the cradle portion to retain the object in the cradle portion.

3. The apparatus of claim 1, wherein the gate portion is arcuately-shaped, a first radius is disposed at a base of the gate portion, a second radius is disposed at a tip of the gate portion, and the second radius is larger than the first radius.

4. The apparatus of claim 1, wherein the gate portion is configured to flex in a first direction relative to the cradle portion to deflect the gate portion away from the cradle opening to permit access to the channel through the cradle opening and the gate portion is configured to resist flexure in a second direction opposite the first direction.

5. The apparatus of claim 1, wherein the cradle portion further comprises:
a first cradle arm spaced apart from a second cradle arm to define a gap therebetween.

6. The apparatus of claim 5, wherein a portion of the gate portion extends into the gap to limit a movement of the object out of the channel.

7. The apparatus of claim 6, wherein the portion of the gate portion limits the movement of the object out of the channel as an angular position of the apparatus changes.

8. The apparatus of claim 7, wherein the gate portion is configured to flex between a closed position and an open position, the gate portion configured to extend into the gap when the gate portion is in the closed position, and the cradle portion configured to receive the object into the channel through the cradle opening when the gate portion is in the open position.

9. The apparatus of claim 1, wherein the mount portion comprises a stud mount connector configured to engage an elongated fastener that extends from the support structure to attach the mount portion to the support structure.

10. The apparatus of claim 9, wherein the stud mount connector further comprises:
a locking head that includes an upper surface and a counterbore that extends into the locking head from the upper surface, the counterbore configured to receive the elongated fastener, the counterbore further comprising at least one thread-engaging pawl tooth configured to engage threads of the elongated fastener.

11. The apparatus of claim 10, wherein the counterbore further comprises:
a chamfer distal the upper surface, the chamfer configured to engage an end of the elongated fastener to provide tactile feedback to a technician.

12. The apparatus of claim 10, wherein the counterbore further comprises:
a stop distal the upper surface, the stop configured to limit an insertion of the elongated fastener into the counterbore.

13. The apparatus of claim 10, wherein the counterbore further comprises:
at least one crush rib that extends from a surface of the counterbore, the crush rib configured to engage the elongated fastener to reduce wobble.

14. The apparatus of claim 13, wherein the crush rib extends axially to the counterbore.

15. The apparatus of claim 1, wherein the cradle portion further comprises:
a first cradle arm comprising a first receiver portion that extends substantially perpendicular to the mount portion and a first upright portion that extends obliquely from the first receiver portion; and
a second cradle arm comprising a second receiver portion that extends substantially perpendicular to the mount portion and a second upright portion that extends obliquely from the second receiver portion, the first cradle arm spaced apart from the second cradle arm.

16. The apparatus of claim 1, the mount portion, the cradle portion, and the gate portion are integral.

17. The apparatus of claim 1, further comprising:
a strap connector configured to receive a strap to secure the object in the channel.

18. The apparatus of claim 1, wherein the mount portion further comprises:
a saddle configured to receive a strap to secure the mount portion to the support structure.

19. The apparatus of claim 18, wherein the cradle portion further comprises:
a first cradle arm spaced apart from a second cradle arm to define a gap therebetween, the saddle centered between the first cradle arm and the second cradle arm.

20. The apparatus of claim 1, wherein the mount portion defines a mount hole connector therethrough that is configured to receive a mechanical fastener therethrough to attach the mount portion to the support structure, and a tip of the gate portion defines a notch configured to receive a tool that engages the mechanical fastener.
